(19) United States
(12) Patent Application Publication
(10) Pub. No.: US 2014/0349166 A1
(43) Pub. Date: Nov. 27, 2014

(54) NONAQUEOUS ELECTROLYTE SECONDARY BATTERY AND METHOD FOR MANUFACTURING THE SAME

(71) Applicant: SANYO Electric Co., Ltd., Moriguchi-shi, Osaka (JP)

(72) Inventors: Takanobu Chiga, Osaka (JP); Naoki Imachi, Hyogo (JP)

(73) Assignee: SANYO ELECTRIC CO., LTD., Moriguchi-shi, Osaka (JP)

(21) Appl. No.: 14/359,836

(22) PCT Filed: Oct. 29, 2012
(86) PCT No.: PCT/JP2012/077846

§ 371 Date: May 21, 2014

(30) Foreign Application Priority Data
Nov. 30, 2011 (JP) 2011-262834

(51) Int. Cl. H01M 4/62; H01M 4/04

(52) U.S. Cl. CPC H01M 4/628; H01M 4/0404; H01M 4/0435
USPC 429/126; 29/623.5; 29/623.3

(57) ABSTRACT

The present invention provides a positive electrode for a nonaqueous electrolyte secondary battery in which after continuous charge is performed, an increase in battery thickness is suppressed, and a residual capacity rate is increased by reduction in gas generation amount and also provides a method for manufacturing the positive electrode described above. This positive electrode includes a positive electrode collector and a positive electrode active material layer which contains a positive electrode active material and a phosphate salt represented by NaH₂PO₄ and which is formed on a surface of the positive electrode collector. In addition, on a surface of the positive electrode active material layer, a porous layer containing an inorganic oxide filler is preferably formed.

### TECHNICAL FIELD

The present invention relates to a nonaqueous electrolyte secondary battery and a method for manufacturing the same.

### BACKGROUND ART

In recent years, since reduction in size and weight of mobile information terminals, such as a mobile phone, a notebook personal computer, and a PDA, has been rapidly progressed, an increase in capacity of a battery used as a drive power source thereof has been required. In order to meet the requirement as described above, as a novel secondary battery having a high output and a high energy density, a nonaqueous electrolyte secondary battery has been widely used.

In particular, entertainment functions, such as movie reproduction and game performance, of a mobile information terminal have been progressively enhanced in recent years, and as a result, the power consumption thereof tends to further increase. Hence, a further increase in capacity of a nonaqueous electrolyte secondary battery has been desired.

As a method to increase the capacity of the nonaqueous electrolyte secondary battery, a method may be conceived in which a charge voltage is set to be high so as to improve a usage rate of a positive electrode active material. For example, when a commonly used lithium cobalate is charged to 4.3 V (4.2 V when a counter electrode is a graphite negative electrode) with reference to metal lithium, the capacity is approximately 160 mAh/g; however, when charge is performed to 4.5 V (4.4 V when the counter electrode is a graphite negative electrode) with reference to metal lithium, the capacity can be increase to approximately 190 mAh/g.

However, when a positive electrode active material, such as lithium cobalate, is charged to a high voltage, a problem in that an electrolytic liquid is liable to be decomposed may arise. In particular, when continuous charge is performed at a high temperature, the electrolytic liquid is decomposed to generate a gas, and as a result, a problem in that the battery is swollen or the internal pressure thereof is increased may occur in some cases.

Accordingly, in order to suppress the decomposition of the electrolytic liquid, the following proposals have been made.

(1) A proposal in which at a synthetic stage of a positive electrode active material, a phosphorus compound, such as P₂O₅, Li₃PO₄, H₃PO₄, or Mg₃ (PO₄)₂·H₂O, is added thereto, and firing is then performed so as to form a composite of the positive electrode active material and the phosphorus compound (see the following Patent Literatures 1 to 3).

(2) A proposal in which after a positive electrode active material is synthesized, NH₄H₂PO₄, (NH₄)₂HPO₄, and/or Li₃PO₄ is mixed therewith, and a heat treatment is then further performed (see the following Patent Literature 4).

(3) A proposal in which at a stage in which a positive electrode slurry is formed, phosphorous acid (H₃PO₃) is added (see the following Patent Literatures 5 and 6).

(4) A proposal in which an ammonium phosphate compound is added to a positive electrode slurry or a negative electrode slurry (see the following Patent Literatures 7 and 8).

### CITATION LIST

### Patent Literature

PTL 1: Japanese Patent No. 3212639
PTL 2: Japanese Patent No. 3054829
PTL 3: Japanese Published Unexamined Patent Application No. 2006-169048
PTL 4: Japanese Published Unexamined Patent Application No. 2010-55717
PTL 5: Japanese Published Unexamined Patent Application No. 2007-335331
PTL 6: Japanese Published Unexamined Patent Application No. 2008-251434
PTL 7: Japanese Published Unexamined Patent Application No. 11-154535
PTL 8: Japanese Published Unexamined Patent Application No. 11-329444

### SUMMARY OF INVENTION

### Technical Problem

According to the above proposal (1), since being added at the synthetic stage of the positive electrode active material, the phosphorus compound is present not only on the surfaces of positive electrode active material grains but also inside thereof. As a result, decomposition of an electrolytic liquid generated on the surface of the positive electrode active material cannot be sufficiently suppressed, and an effect of suppressing gas generation during continuous charge and storage is not sufficient; hence, there has been a problem of battery swelling.

According to the above proposal (2), the effect of suppressing gas generation during continuous charge and storage was also not sufficient.

According to the above proposal (3), the effect of suppressing gas generation during continuous charge and storage was also not sufficient, and in addition, since H₃PO₃ is a strong acid, there has been a problem in that H₃PO₃ which is not allowed to react with the positive electrode active material may corrode a kneading machine.

According to the above proposal (4), the effect of suppressing gas generation during continuous charge and storage was also not sufficient.

### Solution to Problem

The present invention provides a positive electrode including a positive electrode collector and a positive electrode active material layer which contains a positive electrode active material and a phosphorus salt represented by MH₂PO₄ (M indicates a monovalent metal) and which is formed on a surface of the positive electrode collector.

### Advantageous Effects of Invention

According to the present invention, an excellent effect of suppressing gas generation during continuous charge and storage can be obtained.

### BRIEF DESCRIPTION OF DRAWINGS

FIG. 1 is a graph showing a first discharge curve of each of batteries A1 and Z1 to Z3 after a continuous charge test is performed.

FIG. 2 is a graph showing the impedance of each of batteries A1, B2, Z2, and Z3.

### DESCRIPTION OF EMBODIMENTS

Hereinafter, although the present invention will be described with reference to the following embodiments, the present invention is not limited at all to the following embodiments and may be appropriately changed and modified without departing from the scope of the present invention.

### First Example

### Example 1

Hereinafter, formation of a battery A1 will be described.

### [Formation of Positive Electrode]

LiCoO₂ (in which 1.0 percent by mole of A1 and 1.0 percent by mole of Mg are solid-soluted, and 0.05 percent by mole of Zr is adhered on the surface) functioning as a positive electrode active material, AB (acetylene black) functioning as an electrically conductive agent, and a PVDF (poly(vinylidene fluoride)) functioning as a binding agent were kneaded together with NMP (N-methyl-2-pyrrolidone) functioning as a solvent. In this step, the mass ratio of LiCoO₂, AB, and PVDF was set to 95:2.5:2.5. Next, after a NaH₂PO₄ powder was added at a rate of 0.1 percent by mass with respect to the above positive electrode active material, stirring was further performed, so that a positive electrode slurry was prepared. Subsequently, after the positive electrode slurry was applied on two surfaces of a positive electrode collector formed of aluminum foil, drying and rolling were sequentially performed, so that a positive electrode was obtained. In addition, the packing density of the positive electrode was set to 3.8 g/cc. The NaH₂PO₄ powder was a powder obtained by passing a powder pulverized using a mortar through a mesh having an opening of 20 μm.

### [Formation of Negative Electrode]

Graphite functioning as a negative electrode active material, a SBR (styrene butadiene rubber) functioning as a binding agent, and a CMC (carboxylmethyl cellulose) functioning as a thickening agent were kneaded together in an aqueous solution, so that a negative electrode slurry was prepared. In this step, the mass ratio of the graphite, the SBR, and the CMC were set to 98:1:1. Next, after this negative electrode slurry was applied on two surfaces of a negative electrode collector formed of copper foil, drying and rolling were sequentially performed, so that a negative electrode was obtained.

### [Preparation of Nonaqueous Electrolytic Liquid]

As a solvent of a nonaqueous electrolytic liquid, a mixed solvent in which ethylene carbonate (EC), ethyl methyl carbonate (EMC), and diethyl carbonate (DEC) were mixed together at a volume ratio of 3:6:1 was used, and to this mixed solvent, LiPF₆ functioning as a solute was added at a rate of 1.0 mol/l. In addition, with respect to 100 parts by weight of this electrolytic liquid, vinylene carbonate functioning as an additive was added at a rate of 2 parts by weight.

### [Assembly of Battery]

Lead terminals were fitted to the respective positive and negative electrodes thus formed. Next, after at least one separator was disposed between the positive and negative electrodes, a spiral shape was formed by winding thereof and was further pressed, so that a flatly pressed electrode body was formed. Next, this electrode body was disposed inside a battery exterior package formed of an aluminum laminate, and the nonaqueous electrolytic liquid was charged therein. Finally, the battery exterior package was sealed, so that a test battery A1 was formed. Incidentally, the battery A1 has a designed capacity of 800 mAh and a size of 3.6 mm×35 mm×62 mm. The above designed capacity is designed based on a charge final voltage of 4.4 V.

### Example 2

Except that in the preparation of the positive electrode slurry, LiH₂PO₄ was added instead of NaH₂PO₄, a battery was formed in a manner similar to that of the battery A1.

The battery thus formed is hereinafter called a battery A2.

### Comparative Example 1

Except that in the preparation of the positive electrode slurry, NaH₂PO₄ was not added, a battery was formed in a manner similar to that of the battery A1.

The battery thus formed is hereinafter called a battery Z1.

### Comparative Example 2

Except that in the preparation of the positive electrode slurry, a solution in which H₃PO₃ was dissolved in NMP was added instead of NaH₂PO₄, a battery was formed in a manner similar to that of the battery A1. In addition, the rate of H₃PO₃ to the positive electrode active material was 0.1 percent by mass.

The battery thus formed is hereinafter called a battery Z2.

### Comparative Example 3

Except that in the preparation of the positive electrode slurry, an aqueous solution of H₃PO₄ at a concentration 90% was added instead of NaH₂PO₄, a battery was formed in a manner similar to that of the battery A1. In addition, the rate of H₃PO₄ to the positive electrode active material was 0.1 percent by mass.

The battery thus formed is hereinafter called a battery Z3.

### Comparative Example 4

Except that in the preparation of the positive electrode slurry, Na₂HPO₄ was added instead of NaH₂PO₄, a battery was formed in a manner similar to that of the battery A1.

The battery thus formed is hereinafter called a battery Z4.

### Comparative Example 5

Except that in the preparation of the positive electrode slurry, Na₃PO₄ was added instead of NaH₂PO₄, a battery was formed in a manner similar to that of the battery A1.

The battery thus formed is hereinafter called a battery Z5.

### Comparative Example 6

Except that in the preparation of the positive electrode slurry, Li₃PO₄ was added instead of NaH₂PO₄, a battery was formed in a manner similar to that of the battery A1.

The battery thus formed is hereinafter called a battery Z6.

### Comparative Example 7

Except that in the preparation of the positive electrode slurry, Na₂H₂P₂O₇ was added instead of NaH₂PO₄, a battery was formed in a manner similar to that of the battery A1.

The battery thus formed is hereinafter called a battery Z7.

### Comparative Example 8

Except that in the preparation of the positive electrode slurry, Mg(H₂PO₄)₂.4H₂O was added instead of NaH₂PO₄, a battery was formed in a manner similar to that of the battery A1.

The battery thus formed is hereinafter called a battery Z8.

### Comparative Example 9

Except that in the preparation of the positive electrode slurry, Al(H₂PO₄)₃ was added instead of NaH₂PO₄, a battery was formed in a manner similar to that of the battery A1.

The battery thus formed is hereinafter called a battery Z9.

### (Experiment)

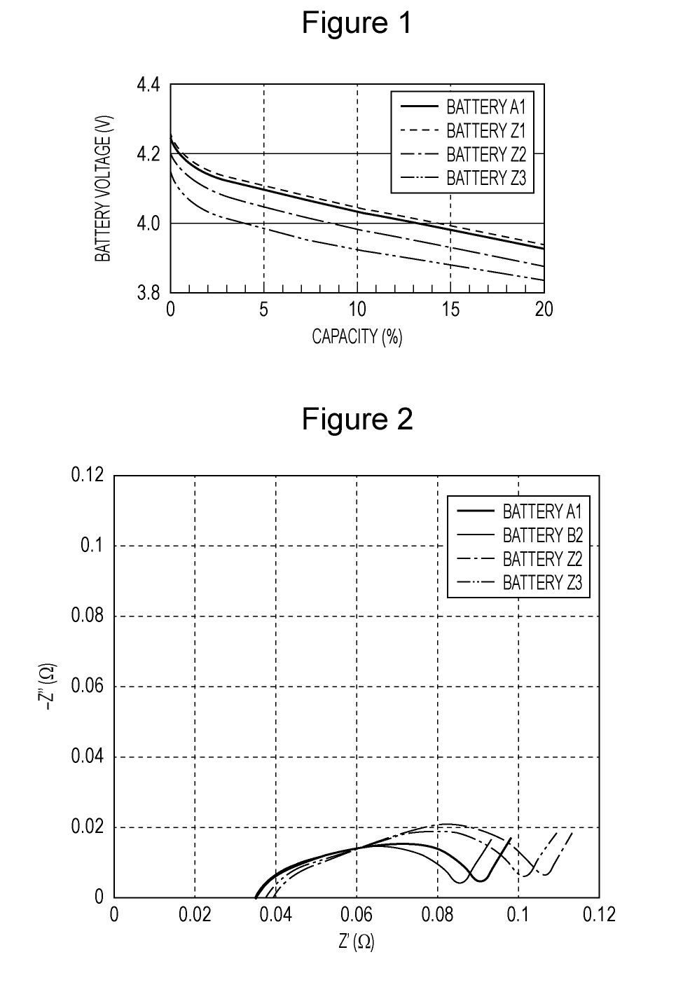

Charge and discharge of each of the batteries A1, A2, and Z1 to Z9 were performed under the following conditions, and an increase in battery thickness shown by the following formula (1) and a residual capacity rate shown by the following formula (2) were then measured. The results thus obtained are shown in Table 1. In addition, a first discharge curve of each of the batteries A1 and Z1 to Z3 after a continuous charge test is shown in FIG. 1.

Before the continuous charge test was performed, first constant current charge was performed to 4.4 V at a current of 1.0 It (800 mAh), and charge was further performed at a constant voltage to a current of 1/20 It (40 mA). After a rest of 10 minutes was taken, constant current discharge was performed to 2.75 V at a current of 1.0 It. In the discharge, a discharge capacity Q1 before the continuous charge test was measured. After the discharge, charge was performed under the conditions similar to those described above, and a battery thickness L1 before the continuous charge test was measured.

After the battery thickness L1 was measured, as the continuous charge test, the batteries were each disposed in a constant-temperature bath at 60° C., and charge was performed at a constant voltage of 4.4 V for 65 hours. Subsequently, a battery thickness L2 after the continuous charge test was measured. Finally, after the batteries were each cooled to room temperature, discharge was performed at room temperature. In this discharge, a first discharge capacity Q2 after the continuous charge test was measured.

Increase in Battery Thickness=Battery Thickness L2−Battery Thickness L1 (1)

Residual Capacity Rate=(Discharge Capacity Q2/Discharge Capacity Q1)×100 (2)

TABLE 1

| | | | | Residual |
|---|---|---|---|---|
| | | Addition | Increase in | Capacity |
| | | Amount | Battery | Rate |
| Battery | Type of Additive | (Mass %) | Thickness (mm) | (%) |
| A1 | NaH₂PO₄ | 0.1 | 0.51 | 91.4 |
| A2 | LiH₂PO₄ | | 0.47 | 89.5 |
| Z1 | None | — | 1.38 | 86.6 |
| Z2 | H₃PO₃ | 0.1 | 0.54 | 88.8 |
| Z3 | H₃PO₄ | | 0.63 | 86.4 |
| Z4 | Na₂HPO₄ | | 1.23 | 87.4 |
| Z5 | Na₃PO₄ | | 1.31 | 87.4 |
| Z6 | Li₃PO₄ | | 1.43 | 86.6 |
| Z7 | Na₂H₂P₂O₇ | | 1.32 | 87.5 |
| Z8 | Mg(H₂PO₄)₂•4H₂O | | 0.79 | 88.1 |
| Z9 | Al(H₂PO₄)₃ | | 1.11 | 87.8 |

As apparent from the above Table 1, since the amount of generated gas of each of the batteries A1 and A2 is small as compared to that of each of the batteries Z1 to Z9, it is recognized that the increase in battery thickness is decreased, and the residual capacity rate is increased. The reason the amount of generated gas of each of the batteries A1 and A2 is decreased as described above is believed that NaH₂PO₄ and LiH₂PO₄ each trap radicals generated on the positive electrode. Incidentally, NaH₂PO₄ and LiH₂PO₄ are each an acidic substance. Hence, it may also be construed that an alkaline component, such as lithium hydroxide, which remains as an impurity of the positive electrode active material is consumed by an acidic substance, such as NaH₂PO₄ or LiH₂PO₄, and hence, the gas generation is suppressed. However, in the batteries Z2 and Z3 in which H₃PO₃ and H₃PO₄ are added, although H₃PO₃ or the like has a high acidity as compared to that of NaH₂PO₄ or the like, the amount of generated gas is larger than that in each of the batteries A1 and A2. From the results as described above, it is believed that the reduction in amount of generated gas is primarily caused by trapping of radicals generated on the positive electrode performed by NaH₂PO₄ or the like.

In addition, when the positive electrode is formed, if a NaH₂PO₄ powder or a LiH₂PO₄ powder is added to a kneaded compound of the positive electrode active material, the electrically conductive agent, and the binding agent, and a heat treatment other that drying is not performed, the phosphorus compound can be made present only on the surfaces of positive electrode active material grains. Since the phosphorus compound is present on the positive electrode active material, it is believed that the effect of trapping radicals generated on the positive electrode can be enhanced.

As apparent from FIG. 1, in the first discharge after the continuous charge test, the discharge voltage of the battery A1 in which NaH₂PO₄ is added is not so much decreased as compared to that of the battery Z1 in which nothing is added. On the other, in the first discharge after the continuous charge test, the discharge voltage of each of the batteries Z2 and Z3 in which H₃PO₃ and H₃PO₄ are added, respectively, is remarkable decreased as compared to that of the battery A1. In this case, since NaH₂PO₄ used in the battery A1 has a low acidity (approximately pH 4.5 in a state of an aqueous solution at a concentration of 1.2 percent by mass) and is not likely to react with the positive electrode active material, a resistive layer is difficult to be formed on the surface of the positive electrode active material. Hence, it is believed that since degradation of the positive electrode active material is suppressed by the addition of NaH₂PO₄, the battery A1 can maintain the discharge voltage at a level approximately equivalent to that of the battery Z1. On the other hand, since H₃PO₃ and H₃PO₄ used in the batteries Z2 and Z3, respectively, have a high acidity and are liable to react with the positive electrode active material, the resistive layer is liable to be formed on the surface of the positive electrode active material. Hence, it is believed that in the batteries Z2 and Z3, since the positive electrode active material is degraded, the discharge voltage is decreased as compared to that of the battery A1.

In addition, in one of the batteries Z4 to Z7 in which Na₂HPO₄, Na₃PO₄, Li₃PO₄, or Na₂H₂P₂O₇ is added, the effect of suppressing gas generation cannot be obtained as compared to that of the batteries A1 and A2, and in the battery Z8 or Z9 in which Mg(H₂PO₄)₂₋₄H₂O or Al(H₂PO₄)₂ is added, the effect of suppressing gas generation is not sufficient as compared to that of the batteries A1 and A2.

From the results described above, it is found that as the material to be added to the positive electrode, a phosphate salt represented by MH₂PO₄ (M indicates sodium or lithium) is preferable.

In addition, although the reasons the residual capacity rate of each of the batteries A1 and A2 is higher than that of each of the batteries Z1 to Z9 have not been clearly understood, since the gas generation in each of the batteries A1 and A2 can be suppressed as compared to that of each of the batteries Z1 to Z9, inhibition of charge and discharge at a gas generation portion can be suppressed, and this suppression may be considered as one of the reasons.

In addition, as described above, the acidity of each of the phosphate salts used in the batteries A1 and A2 is not so high. Hence, an apparatus (such as a kneading machine) used for preparation of the positive electrode slurry can be suppressed from being corroded.

### Second Example

### Example 1

Except that in the preparation of the positive electrode slurry, the addition amount of NaH₂PO₄ was set to 0.05 percent by mass, a battery was formed in a manner similar to that of the battery A1.

The battery thus formed is hereinafter called a battery B1.

### Example 2

Except that in the preparation of the positive electrode slurry, the addition amount of NaH₂PO₄ was set to 0.02 percent by mass, a battery was formed in a manner similar to that of the battery A1.

The battery thus formed is hereinafter called a battery B2.

### (Experiment 1)

Charge and discharge of the batteries B1 and B2 were performed under conditions similar to those of the experiment of the first example, and the increase in battery thickness shown by the above formula (1) and the residual capacity rate shown by the above formula (2) were measured. The results thus obtained are shown in Table 2. In addition, in Tablet, the results of the batteries A1 and Z1 are also shown.

TABLE 2

| | | Addition | Increase in | Residual Capacity |
|---|---|---|---|---|
| | Type of | Amount | Battery Thickness | Rate |
| Battery | Additive | (Mass %) | (mm) | (%) |
| A1 | NaH₂PO₄ | 0.1 | 0.51 | 91.4 |
| B1 | | 0.05 | 0.71 | 89.8 |
| B2 | | 0.02 | 0.96 | 89.3 |
| Z1 | None | — | 1.38 | 86.6 |

As apparent from Table 2, it is recognized that as the addition amount of NaH₂PO₄ is increased, the increase in battery thickness is suppressed, and in addition, the residual capacity rate is increased.

### (Experiment 2)

An alternating-current impedance of each of the batteries A1, B2, Z2, and Z3 was measured, and the results thereof are shown in Table 2. In addition, before the continuous charge test shown in the above Experiment 1 was performed, this experiment was performed under the following conditions.

Charge Conditions

Constant current charge was performed to 4.4 V at a current of 1.0 It (800 mA), and furthermore, charge was performed at a constant voltage to a current of 1/20 It (40 mA).

Alternating-Current Impedance Measurement

The frequency was changed from 1 MHz to 30 mHz at an amplitude of 10 mV.

As apparent from FIG. 2, it is recognized that the impedance of the battery A1 in which the addition amount of NaH₂PO₄ is 0.1 percent by mass is increased as compared to that of the battery B2 in which the addition amount of NaH₂PO₄ is 0.02 percent by mass.

From the results of Experiment 1, it was found that when the addition amount of NaH₂PO₄ is excessively small, reduction in increase in battery thickness and improvement in residual capacity rate cannot be sufficiently achieved. From the results of Experiment 2, it was found that when the addition amount of NaH₂PO₄ is excessively large, the impedance is increased. Hence, the rate of the phosphate salt (NaH₂PO₄) to the positive electrode active material is preferably 0.001 percent by mass or more and in particular, preferably 0.02 percent by mass or more. In addition, the rate of the phosphate salt (NaH₂PO₄) to the positive electrode active material is preferably 2 percent by mass or less and in particular, preferably 1 percent by mass or less.

In addition, as apparent from FIG. 2, when the batteries A1, Z2, and Z3, in each of which the addition amount is 0.1 percent by mass, are compared to each other, the impedance of the battery A1 is decreased as compared to that of each of the batteries Z2 and Z3. Hence, in order to suppress the increase in impedance, NaH₂PO₄ is also preferably used as the additive.

### Third Example

### Example 1

Except that as the positive electrode active material, a mixture of LiCoO₂ (in which 1.0 percent by mole of Al and 0.1 percent by mole of Mg were solid-soluted, and in addition, 0.05 percent by mole of Zr was adhered on the surface) and LiNi_{0.5}CO_{0.2}Mn_{0.2} was used, the packing density of the positive electrode was set to 3.6 g/cc, and porous layers are formed on two surfaces of positive electrode active material layers, a battery C1 was formed in a manner similar to that of the battery A1. In addition, in the preparation of the positive electrode slurry, the mass ratio of LiCoO₂, LiNi_{0.5}CO_{0.2}Mn_{0.2}, AB, and PVDF were set to 66.5:28.5:2.5:2.5.

### [Formation of Porous Layer of Battery C1]

By the use of water functioning as a solvent, alumina (trade name AKP3000, manufactured by Sumitomo Chemical Co., Ltd.) functioning as a filler, an SBR (styrene-butadiene rubber) functioning as a water-based binder, and a CMC (carboxylmethyl cellulose) functioning as a dispersing agent, a water-based slurry to form a porous layer was prepared. When the above water-based slurry was prepared, a solid component concentration of the filler was set to 20 percent by mass, and with respect to 100 parts by mass of the filler, the water-based binder and the CMC were added so that the amounts thereof were 3 parts by mass and 0.5 parts by mass, respectively. As a dispersing machine used in the water-based slurry preparation, Filmix manufactured by Primix Corporation was used. Next, after the water-based slurry was applied on the two surfaces of the positive electrode active material layers by using a gravure method, the water functioning as a solvent was dried and removed, so that the porous layers were formed on the two surfaces of the positive electrode active material layers. The porous layer is formed so as to have a thickness of 2 μm per one side (total thickness on the two surfaces: 4 μm).

### Example 2

Except that the porous layers were not formed on the two surfaces of the positive electrode active material layers, a battery was formed in a manner similar to that of the battery C1.

The battery formed as described above is hereinafter called a battery C2.

### Comparative Example 1

Except that in the preparation of the positive electrode slurry, NaH₂PO₄ was not added, a battery was formed in a manner similar to that of the battery C1.

The battery formed as described above is hereinafter called a battery Y1.

### Comparative Example 2

Except that in the preparation of the positive electrode slurry, NaH₂PO₄ was not added, a battery was formed in a manner similar to that of the battery C2.

The battery formed as described above is hereinafter called a battery Y2.

### (Experiment)

Charge, discharge, and the like of the batteries C1, C2, Y1, and Y2 were performed under conditions similar to those of the experiment of the first example, and the increase in battery thickness shown by the above formula (1) and the residual capacity rate shown by the above formula (2) were measured. The results thus obtained are shown in Table 3.

TABLE 3

| | | | | Increase in | |
|---|---|---|---|---|---|
| | | Addition | | Battery | Residual |
| | Type of | Amount | Presence of | Thickness | Capacity |
| Battery | Additive | (Mass %) | Porous Layer | (mm) | Rate (%) |
| C1 | NaH₂PO₄ | 0.1 | Yes | 0.21 | 91.1 |
| Y1 | None | — | | 0.32 | 84.8 |
| C2 | NaH₂PO₄ | 0.1 | No | 0.49 | 79.8 |
| Y2 | None | — | | 0.62 | 74.2 |

As apparent from Table3, when the batteries C1 and Y1, in each of which the porous layer is formed on the surface of the positive electrode active material layer, are compared to each other, it is recognized that in the battery C1 in which NaH₂PO₄ is added, the increase in battery thickness is small, and the residual capacity rate is high as compared to those of the battery Y1 in which NaH₂PO₄ is not added. Hence, even if the porous layer is formed on the surface of the positive electrode active material layer, NaH₂PO₄ is preferably added to the positive electrode.

In addition, when the batteries C2 and Y2, in each of which the porous layer is not formed on the surface of the positive electrode active material layer, are compared to each other, it is recognized that in the battery C2 in which NaH₂PO₄ is added, the increase in battery thickness is small, and the residual capacity rate is high as compared to those of the battery Y2 in which NaH₂PO₄ is not added. Hence, even if a positive electrode active material containing nickel is used as the positive electrode active material, NaH₂PO₄ is preferably added to the positive electrode.

In addition, it is recognized that in the battery C1 in which the porous layer is formed on the surface of the positive electrode active material layer, the increase in battery thickness is further smaller, and the residual capacity rate is further higher than those of the battery C2 in which the porous layer is not formed on the surface of the positive electrode active material layer. The reason for this is that when the porous layer is formed on the surface of the positive electrode active material layer, an oxidative decomposition product of the electrolytic liquid generated on the positive electrode is trapped by the porous layer. Hence, the oxidative decomposition product is suppressed from moving toward the negative electrode, so that further decomposition performed on the negative electrode can be suppressed.

### (Other Items)

(1) In the phosphate salt represented by MH₂PO₄, M is not limited to sodium and lithium, and for example, potassium may also be used.

(2) The porous layer may be formed on the electrode by applying either a solvent-based slurry or a water-based slurry. However, since the positive electrode active material layer functioning as an under layer is generally formed by applying a solvent base (NMP/PVDF), if the porous layer is formed using a solvent base, the PVDF contained in the under layer may swell, and as a result, the electrode thickness may be increased in some cases; hence, the porous layer is preferably formed by applying a water base. As a filler of the porous layer, an inorganic oxide, such as alumina, titania, or silica, may be used. As a material of the water-based binder, for example, a polytetrafluoroethylene (PTFE), a polyacrylonitrile (PAN), a styrene-butadiene rubber (SBR), and a denatured material or a derivative thereof may be preferably used, and in addition, a copolymer containing an acrylonitrile unit, a poly(acrylic acid) derivative, and the like may also be preferably used. In addition, in order to adjust the viscosity in application, a thickening agent, such as a CMC, may also be used.

(3) As the positive electrode active material, any material may be used without any limitation as long as being able to occlude and release lithium and having a noble potential, and for example, a lithium transition metal composite oxide having a layer structure, a spinel structure, or an olivine structure may be used. Among those mentioned above, in view of a high energy density, a lithium transition metal composite oxide having a layer structure is preferably used. As the lithium transition metal composite oxide as described above, for example, a lithium-nickel composite oxide, a lithium-nickel-cobalt composite oxide, a lithium-nickel-cobalt-aluminum composite oxide, a lithium-nickel-cobalt-manganese composite oxide, or a lithium-cobalt composite oxide may be mentioned.

In particular, in view of the stability of the crystalline structure, a lithium cobalate in which Al or Mg is solid-soluted inside the crystal, and in which Zr is fixed to the grain surface is preferable.

In addition, in order to reduce the usage of expensive cobalt, a lithium transition metal composite oxide in which the rate of nickel occupied in transition metals contained in the positive electrode active material is 40 percent by mole or more is preferable, and in view of the stability of the crystalline structure, in particular, a lithium transition metal composite oxide containing nickel, cobalt, and aluminum is preferable.

(4) The negative electrode active material is not particularly limited, and any material which can be used as a negative electrode active material of a nonaqueous electrolyte secondary battery may be used. In particular, for example, a carbon material, such as graphite or coke, a metal oxide, such as tin oxide, a metal, such as silicon or tin, which can form an alloy with lithium and occlude lithium, and metal lithium may be mentioned. Among those mentioned above, a graphite-based carbon material is preferable since the volume change in association with occlusion and release of lithium is small, and the reversibility is excellent.

(5) As the solvent of the nonaqueous electrolyte, solvents, each of which has been used as a solvent of an electrolyte of a nonaqueous electrolyte secondary battery, may be used. Among those solvents, in particular, a mixed solvent of a cyclic carbonate and a chain carbonate is preferably used. In this case, the mixing ratio (cyclic carbonate:chain carbonate) of a cyclic carbonate to a chain carbonate is preferably set in a range of 1:9 to 5:5.

As the cyclic carbonate, for example, ethylene carbonate, fluoroethylene carbonate, propylene carbonate, butylene carbonate, vinylene carbonate, and vinyl ethylene carbonate may be mentioned. As the chain carbonate, for example, dimethyl carbonate, methyl ethyl carbonate, and diethyl carbonate may be mentioned.

(6) As the solute of the nonaqueous electrolyte, for example, LiPF₆, LiBF₄, LiCF₃SO₃, LiN(SO₂F)₂, LiN(SO₂CF₃)₂, LiN(SO₂C₂F₅)₂, LiC(SO₂CF₃)₃, LiC(SO₂C₂F₅)₃, LiClO₄, or a mixture thereof may be mentioned.

(7) As the electrolyte, a gel polymer electrolyte in which a polymer, such as a poly(ethylene oxide) or a polyacrylonitrile, is impregnated with an electrolytic liquid may also be used.

### INDUSTRIAL APPLICABILITY

Hence, the present invention can be expected to be widely used for drive power sources of mobile information terminals, such as a mobile phone, a notebook personal computer, and a PDA and also for drive power sources of high-output apparatuses, such as a HEV and an electric tool.

1. A positive electrode for a nonaqueous electrolyte secondary battery, the positive electrode comprising:
a positive electrode collector; and
a positive electrode active material layer which contains a positive electrode active material and a phosphate salt represented by MH₂PO₄, wherein M is a monovalent metal, and which is formed on a surface of the positive electrode collector.

2. The positive electrode for a nonaqueous electrolyte secondary battery according to claim 1,
wherein M of the MH₂PO₄ is sodium, lithium, or potassium.

3. The positive electrode for a nonaqueous electrolyte secondary battery according to claim 1,
wherein the rate of the phosphate salt to the positive electrode active material is 0.001 to 2 percent by mass.

4. The positive electrode for a nonaqueous electrolyte secondary battery according to claim 3,
wherein the rate of the phosphate salt to the positive electrode active material is 0.02 to 1 percent by mass.

5. The positive electrode for a nonaqueous electrolyte secondary battery according to claim 1,
further comprising a porous layer containing an inorganic filler on a surface of the positive electrode active material layer.

6.-10. (canceled)
